(19) United States
(12) Patent Application Publication
(10) Pub. No.: US 2016/0124522 A1
(43) Pub. Date: May 5, 2016

(54) ELECTRONIC DEVICE, METHOD, STORAGE MEDIUM

(71) Applicant: Kabushiki Kaisha Toshiba, Tokyo (JP)

(72) Inventor: Sotaro Sumitomo, Ome Tokyo (JP)

(21) Appl. No.: 14/688,280

(22) Filed: Apr. 16, 2015

Related U.S. Application Data
(60) Provisional application No. 62/072,310, filed on Oct. 29, 2014.

(51) Int. Cl. G06F 3/0346; G06F 3/01

(52) U.S. Cl. CPC G06F 3/0346; G06F 3/017

(57) ABSTRACT

According to one embodiment, an electronic device includes a circuitry. The circuitry is configured to detect an inclination of the electronic device. The circuitry is configured to detect, as a basic position, a position of the electronic device assumed when a user performs a first operation. The circuitry is configured to release a lock on the electronic device when the inclination of the electronic device is a first inclination with respect to the basic position.

### CROSS-REFERENCE TO RELATED APPLICATIONS

This application claims the benefit of U.S. Provisional Application No. 62/072,310, filed Oct. 29, 2014, the entire contents of which are incorporated herein by reference.

### FIELD

Embodiments described herein relate generally to an electronic device, a method and a storage medium.

### BACKGROUND

Various types of electronic devices, such as tablets, PDAs, smartphones, have recently been developed. Many of these devices incorporate touch screen displays for facilitating user input operations.

In these days, there is a tendency for users to prefer large displays as the touch screen displays of the above-mentioned electronic devices.

However, if a large touch screen display is used, both hands must disadvantageously be used to input a password (e.g., a number (a numeric sequence) including four digit selected from 0 to 9) to the display (namely, it is necessary to hold the electronic device by one hand, and to input the password by the other hand).

There is a demand for a technique of overcoming the above disadvantage.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a front view showing the appearance of an electronic device according to an embodiment.

FIG. 2 shows a system configuration of a tablet computer according to the embodiment.

FIG. 3 shows a display in an active state.

FIG. 4 shows a display in an inactive state.

FIG. 5 shows a general lock screen.

FIG. 6 shows a screen for encouraging a user to re-input a password.

FIG. 7 is a block diagram showing the functional configuration of an unlock application according to the embodiment.

FIG. 8 shows a lock screen according to the embodiment.

FIG. 9 shows a screen, according to the embodiment, for encouraging a user to re-input a password.

FIG. 10 is a flowchart for explaining a procedure of unlock processing according to the embodiment.

FIG. 11 shows a lock screen viewed when the electronic device of the embodiment is inclined leftward.

FIG. 12 shows a lock screen viewed when the electronic device of the embodiment is inclined rightward.

### DETAILED DESCRIPTION

Various embodiments will be described hereinafter with reference to the accompanying drawings.

In general, according to one embodiment, an electronic device includes a circuitry. The circuitry is configured to detect an inclination of the electronic device. The circuitry is configured to detect, as a basic position, a position of the electronic device assumed when a user performs a first operation. The circuitry is configured to release a lock on the electronic device when the inclination of the electronic device is a first inclination with respect to the basic position.

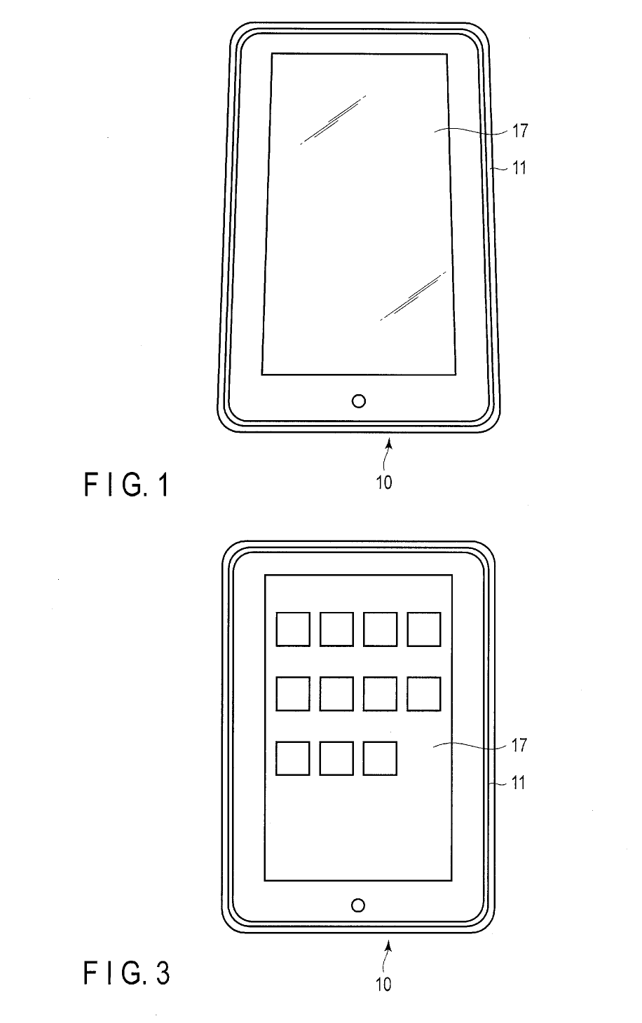

FIG. 1 is a front view showing the appearance of an electronic device according to an embodiment. This electronic device is a mobile device capable of handwriting input using a stylus or a finger. The electronic device can be realized as a tablet computer, a notebook personal computer, a smartphone, a PDA, etc. In the embodiment, the electronic device is assumed to be realized as a tablet computer. The tablet computer denoted by reference number 10 has a housing in a shape of a thin box, and is a mobile device also called a tablet or a slate computer.

A touch screen display (hereinafter referred to simply as a “display”) 17 is attached to a main unit 11, superposed thereon. The display 17 incorporates a flat panel display, and a sensor configured to detect the contact position of a pen or a finger on the screen of the flat panel display. The flat panel display may be a liquid crystal display (LCD) device. The sensor may be an electrostatic capacitance type touch panel or an electromagnetic induction type digitizer. The touch screen display 17 may incorporate both of the two types sensors, i.e., the digitizer and the touch panel. In this case, the display 17 can detect not only a touch operation on the screen using a finger but also a touch operation on the screen using a stylus 100. The stylus 100 is, for example, a digitizer stylus (electromagnetic induction stylus).

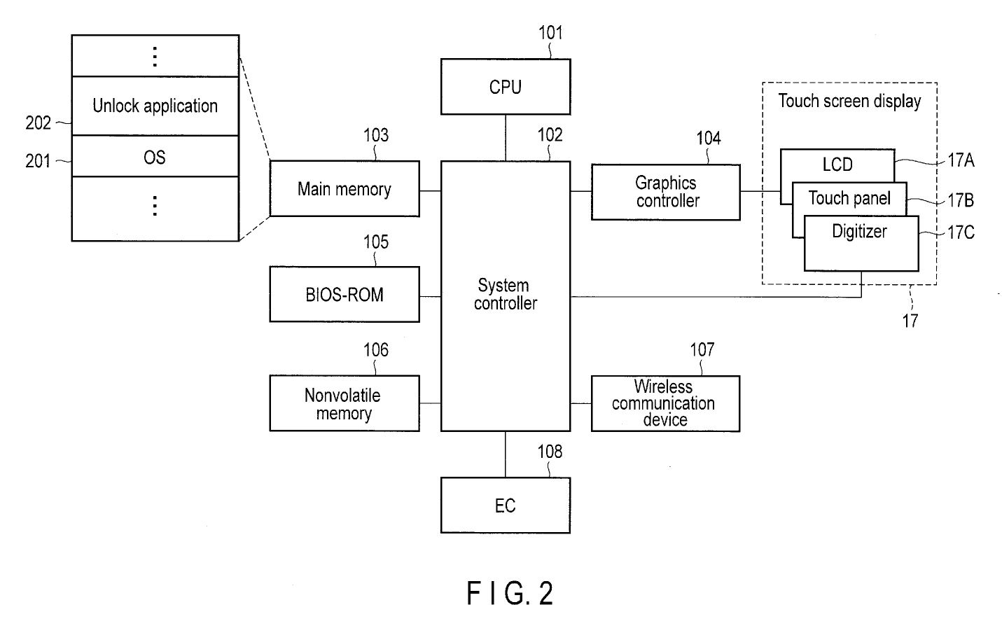

FIG. 2 shows a system configuration of the tablet computer 10.

The tablet computer 10 includes a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor for controlling the operations of various modules in the tablet computer 10. The CPU 101 executes various types of software loaded from the nonvolatile memory 106 to the main memory 103. The software includes an operating system (OS) 201 and various application programs. The application programs include, for example, an unlock application program 202 for performing unlock processing to release a lock set to limit the operation of the tablet computer 10.

The CPU 101 also executes a basic input output system (BIOS) stored in the BIOS-ROM 105. The BIOS is a program for hardware control.

The system controller 102 is a device that connects each component module to a local bus of the CPU 101. The system controller 102 contains a memory controller for controlling access to the main memory 103. The system controller 102 also has a function of communicating with the graphics controller 104 via a serial bus of the PCI EXPRESS standard.

The graphics controller 104 is a display controller for controlling an LCD 17A used as the display monitor of the tablet computer 10. A display signal generated by the graphics controller 104 is sent to the LCD 17A. The LCD 17A displays a screen image based on the display signal. A touch panel 17B, the LCD 17A and a digitizer 17C are superposed on each other. The touch panel 17B is a pointing device of an electrostatic capacitance type used to perform an input on the screen of the LCD 17A. The contact position of a finger on the screen, movement of the contact position, etc., are detected by the touch panel 17B. The digitizer 17C is a pointing device of an electromagnetic induction type. The contact position of the stylus 100 on the screen, movement of the contact position, etc., are detected by the digitizer 17C.

The wireless communication device 107 is a device configured to execute wireless communication, such as a wireless LAN or 3G mobile communication. The EC 108 is a one-chip microcomputer including an embedded controller for power management. The EC 108 has a function of turning on and off the tablet computer 10 in accordance with a user's operation of a power button.

The general function of the tablet computer 10 will be described briefly.

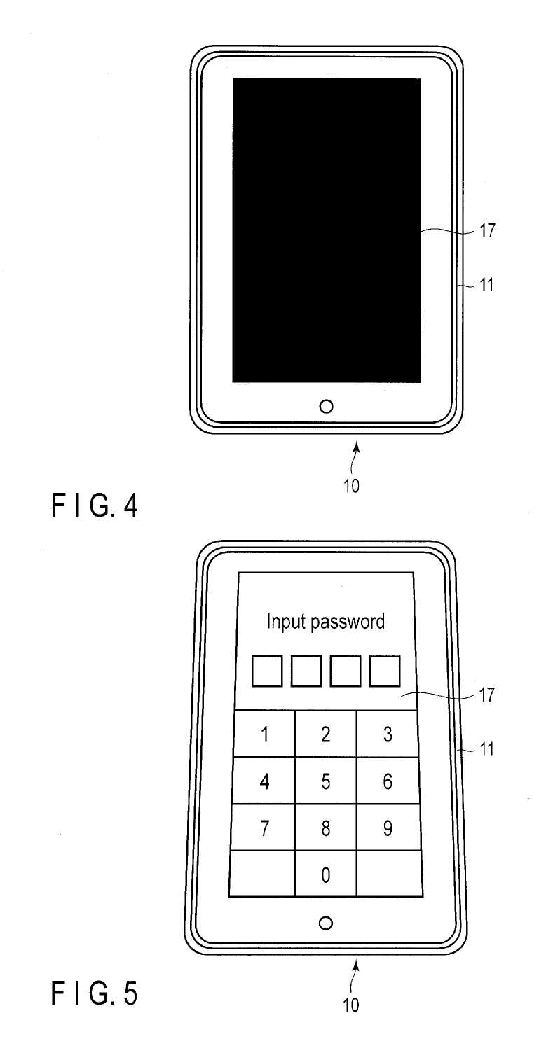

The tablet computer 10 has a function of switching the display 17 from an active state to an inactive state (e.g., turn-off of the backlight of the display 17) in view of power saving when the user performs no operations on the tablet computer 10 for a predetermined period. The active state is indicative of a state where the display 17 displays various icons for activating various application programs installed in the tablet computer 10, a background image, etc., as is shown in FIG. 3. In contrast, the inactive state is indicative of a state where the display 17 displays nothing as show in FIG. 4.

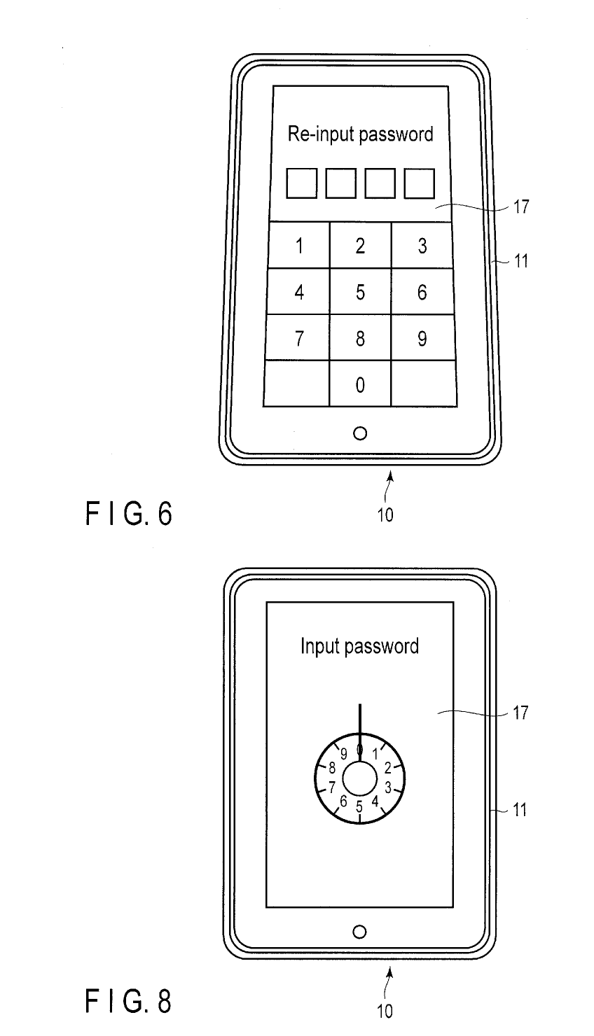

A description will be given of a user operation performed when the screen is switched from that shown in FIG. 4 to that shown in FIG. 3. In general, if the user wishes to again switch the screen from that of FIG. 4 to that of FIG. 3, they perform a predetermined operation, such as pressing a home button provided in the tablet computer 10. As a result, the display 17 of the tablet computer 10 displays such a lock screen as shown in FIG. 5. When the display 17 of the tablet computer 10 displays the lock screen, the user touches the display 17 to input a password (pass-code). If the password input by the user is identical to a pre-registered one, the display 17 of the tablet computer 10 again displays the screen of FIG. 3 (i.e., unlocks the tablet computer 10). In contrast, if the password input by the user is not identical to the pre-registered one, the display 17 of the tablet computer 10 displays a screen for encouraging the user to retype (re-input) the password, as is shown in FIG. 6.

As described above, when the display 17 is returned from the inactive state to the active state, it is common to require the user to retype the password. Regarding the password input, one problem has occurred recently. Namely, there is a recent problem that the display 17 of some tablet computer 10 is too big to input the password by one hand. For instance, when it is necessary to input, as a password, a number (a numeric sequence) including four digits selected from numbers 0 to 9, as shown in, for example, FIG. 5, if the display 17 of the tablet computer 10 is too big, the user must hold the tablet computer by one hand, and input the password by touching the display 17 by the other hand. In this case, if there is an occasion where only one hand is free, the user cannot input the password and hence cannot unlock the tablet computer 10. This is disadvantageous. To overcome the disadvantage, the embodiment provides a password input method that enables the user to input the password easily even when only one hand is free.

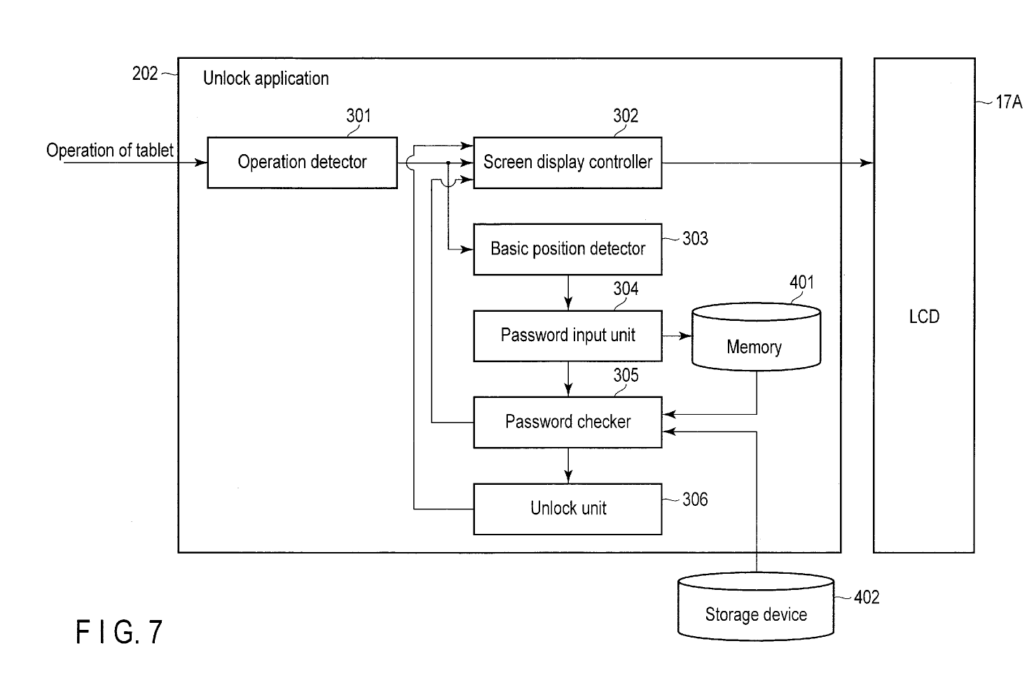

FIG. 7 is a block diagram showing the functional configuration of the unlock application 202 according to the embodiment. As shown in FIG. 7, the unlock application 202 includes an operation detector 301, a screen display controller 302, a basic position detector 303, a password input module 304, a password checker 305, an unlock module 306, a memory 401, etc.

The operation detector 301 detects a user's predetermined operation. More specifically, the operation detector 301 detects a predetermined operation that can be regarded as a trigger for unlocking the tablet computer 10. For instance, the operation detector 301 has a function of detecting an operation, such as a press down of the home button by the user, and informing the screen display controller 302 and the basic position detector 303 of the detection of the operation.

The screen display controller 302 has a function of performing display control of the display 17. For instance, when the display 17 of the tablet computer 10 is in the inactive state, if the screen display controller 302 has been informed by the operation detector 301 of the detection of a predetermined operation (e.g., a press down of the home button), it performs processing of displaying a lock screen image on the display 17. In the embodiment, it is assumed as an example that a dial lock is displayed as the lock screen image on the display 17 as shown in FIG. 8.

When the display 17 of the tablet computer 10 is in the inactive state, if the basic position detector 303 has been informed by the operation detector 301 of the detection of the predetermined operation (e.g., the press down of the home button), the basic position detector 303 executes processing of detecting, as the basic position, the position of the tablet computer 10 assumed upon informed of the detection. The basic position means that the inclination of the tablet computer 10 is substantially zero. Namely, when the display 17 of the tablet computer 10 is in the inactive state, if a predetermined operation has been performed, the basic position detector 303 executes processing of determining that the tablet computer 10 does not incline at all in the current stage.

The password input module 304 has a function of inputting a password in accordance with the degree of inclination relative to the basic position, which has been detected by the basic position detector 303. The degree of inclination relative to the basic position is detected by a gyro sensor (not shown) built in the tablet computer 10. The input password (i.e., password information indicative of the input password) is sent to the password checker 305. The input password may be temporarily stored in the memory 401.

Upon accepting the input of the password sent from the password input module 304, the password checker 305 performs determination processing (check processing) for determining whether the input-accepted password is identical to a password pre-registered in a storage device 402. Assume that the storage device 402 pre-stores a password pre-registered by the user, and that the password checker 305 can read the restored password when necessary.

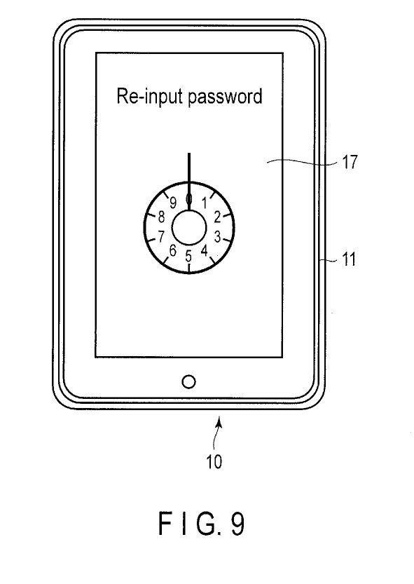

If it is determined as the result of the above-mentioned determination processing that the input-accepted password is identical to the registered password, the password checker 305 executes processing of instructing the unlock module 306 to unlock the tablet computer 10. In contrast, if it is determined as the result of the above-mentioned determination processing that the input-accepted password is not identical to the registered password, the password checker 305 executes processing of instructing the image display controller 302 to display, on the display 17, a screen (such as the screen shown in FIG. 9) that encourages the user to retype the password.

The unlock module 306 has a function of unlocking the tablet computer 10 in accordance with an instruction from the password checker 305. When the tablet computer 10 is unlocked by the unlock module 306, the screen display controller 302 causes the display 17 to re-display the screen image displayed before the lock is made.

Further, the image display controller 302 also executes processing of causing the display 17 to display a screen image for encouraging the user to retype the password, in accordance with an instruction from the password checker 305.

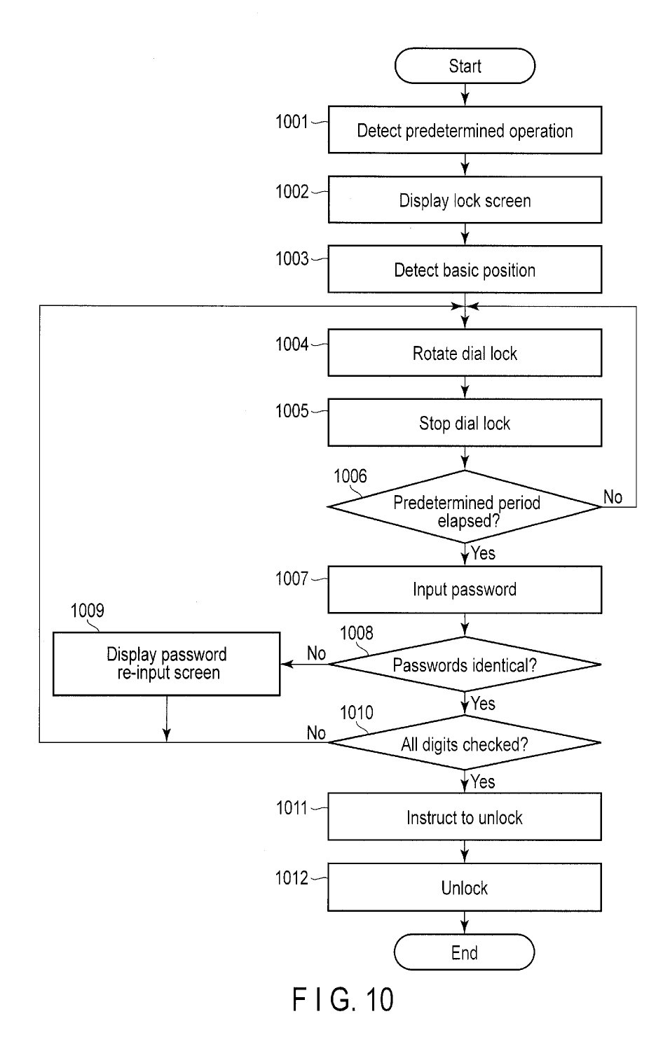

Referring then to the flowchart of FIG. 10, a description will be given of unlock processing performed by the unlock application 202. In this process, it is assumed that the display 17 of the tablet computer 10 is in the inactive state. It is also assumed that the storage device 402 stores a number (numeric sequence) including N digits selected from 0 to 9. It is further assumed that the operation of pressing the home button, which serves as a trigger for unlock processing, is performed by the user.

Firstly, when the operation detector 301 detects press down of the home button by the user, it informs the screen display controller 302 and the basic position detector 303 that the user has pressed down the home button (block 1001).

Upon informed by the operation detector 301 that the home button has been pressed down, the screen display controller 302 causes the display 17 to display the above-mentioned lock screen shown in FIG. 8 (block 1002).

Further, upon informed by the operation detector 301 that the home button has been pressed down, the basic position detector 303 determines that the position of the tablet computer 10 assumed when informed of the press down of the home button corresponds to the basic position, i.e., determines that the inclination of the tablet computer 10 is substantially zero (block 1003).

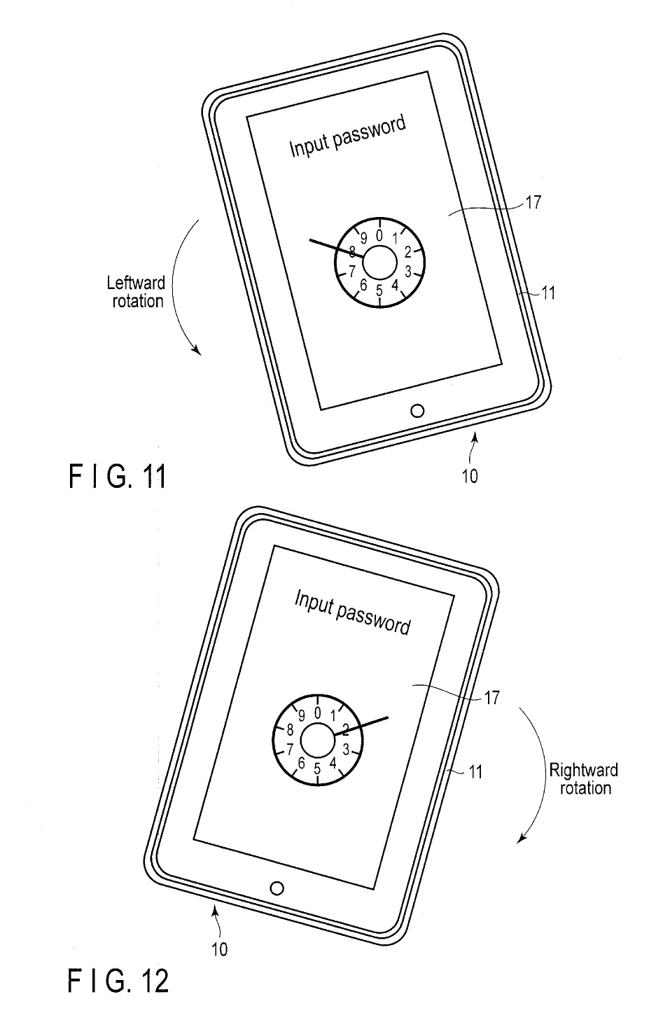

After that, if a gyro sensor (not shown) built in the tablet computer 10 detects that the tablet computer 10 inclines by a predetermined angle or more with respect to the basic position, the screen display controller 302 rotates a dial lock on the lock screen, displayed on the display 17, in a direction in which the tablet computer 10 inclines (block 1004). For instance, if the tablet computer 10 inclines leftward by the predetermined angle or more with respect to the basic position as shown in FIG. 11, the screen display controller 302 performs screen display control as if the dial lock looks to be rotated leftward. Similarly, if the tablet computer 10 inclines rightward by the predetermined angle or more with respect to the basic position as shown in FIG. 12, the screen display controller 302 performs screen display control as if the dial lock looks to be rotated rightward. At this time, the screen display controller 302 performs screen display control so that only a pointer included in the elements (a dial plate and the pointer) of the dial lock looks to be rotated as shown in FIGS. 11 and 12. Namely, the screen display controller 302 rotates only the pointer, with the dial plate fixed in position regardless of the inclination of the tablet computer 10. As a result, numbers 0 to 9 are set sequentially selectable.

After that, if the gyro sensor built in the tablet computer 10 detects that the tablet computer 10 is returned from the state, in which it inclines by the predetermined angle or more, to the basic position (or substantially basic position), the screen display controller 302 stops the rotation of the dial lock on the lock screen displayed on the display 17 (block 1005).

Subsequently, the password input module 304 determines whether a predetermined time period, preferably, 1.5 to 2 sec., has elapsed with the dial lock on the lock screen of the display 17 stopped, based on information sent from the gyro sensor built in the tablet computer 10 (i.e., information indicative of whether the basic position or substantially basic position is maintained, in other words, information indicative of that the tablet computer does not incline by the predetermined angle or more from the basic position) (block 1006). The predetermined time period can be arbitrarily set by the user.

If the determination result in block 1006 indicates that the predetermined time period has not elapsed with the dial lock on the lock screen stopped, i.e., if the gyro sensor detects that the tablet computer 10 again inclines by the predetermined angle or more with respect to the basic position (or substantially basic position) (No in block 1006), the program returns to the above-mentioned block 1004.

In contrast, if the determination result in block 1006 indicates that the predetermined time period has elapsed with the dial lock on the lock screen stopped, i.e., if the gyro sensor detects that the tablet computer 10 keeps the basic position (or substantially basic position) (Yes in block 1006), the password input module 304 inputs the number selected by the dial lock on the lock screen displayed on the display 17 (namely, the number indicated by the pointer of the dial lock), as an Nth (Nth digit) (e.g., first digit) password number (block 1007). The input password (password information indicative of the password) is timely sent to the password checker 305.

Upon receiving the password from the password input module 304, the password checker 305 reads pre-stored password from the storage device 402, and determines whether the input-accepted password (number) is identical to the Nth digit of the read password (block 1008).

If it is determined from the determination result in block 1008 that the two passwords are not identical to each other (No in block 1008), the screen display controller 302 causes the display 17 to display the above-mentioned screen shown in FIG. 9 to encourage the user to retype the password (block 1009), followed by the program returning to block 1004.

In contrast, if it is determined from the determination result in block 1008 that the two passwords are identical to each other (Yes in block 1008), the password checker 305 determines whether password checking has been performed on all of the N digits (block 1010).

If it is determined from the determination result in block 1010 that password checking has not been performed on all of the N digits (No in block 1010), the program returns to the above-mentioned block 1004, where the same processing is performed on a subsequent digit. For instance, when the password is a number (a numeric sequence) including four digits, and password checking has been performed only on the first digit of the password, the program returns to the above-mentioned block 1004, where the same processing as on the first digit is performed on the second digit of the password. The third and fourth digits of the password are processed in the same way.

In contrast, if it is determined from the determination result in block 1010 that password checking has been performed on all of the N digits (Yes in block 1010), the password checker 305 instructs the unlock module 306 to unlock the tablet computer 10 (block 1011).

Upon receiving the instruction to unlock the tablet computer 10, the unlock module 306 executes processing of unlocking the tablet computer 10 (block 1012). As a result, the screen image immediately before the tablet computer 10 is locked can be displayed again on the display 17.

Although in the embodiment, the password for unlocking the tablet computer 10 is a number (number sequence) including N digits selected from 0 to 9, it may be, for example, a combination of digits and alphabet letters, or a combination of figures. Further, the password may include a direction in which the dial lock is rotated, as well as the above-mentioned digits, alphabet letters and figures. By thus including, in the password, the direction in which the dial lock is rotated, a password that is harder to detect than a password including only digits, alphabet letters and figures can be set.

Further, although in the embodiment, check processing is performed whenever one digit of a password is input, only one check may be performed after all digits of the password are input, for example.

Since the above-described embodiment employs a structure in which a password for unlocking the tablet computer 10 is input in accordance with the inclination of the tablet computer 10 detected by a gyro sensor built in the tablet computer 10, the tablet computer 10 can be easily unlocked even when only one hand is usable.

Yet further, since the password can be input without touching the display 17 of the tablet computer 10, no finger print is left on the display 17 when the password is input. Therefore, even if, for example, the tablet computer 10 is stolen, the tablet computer is free from a disadvantage that the password is analogized from a finger print left on the display 17 to thereby unlock the tablet computer 10.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
circuitry configured to:
detect an inclination of the electronic device;
detect, as a basic position, a position of the electronic device assumed when a user performs a first operation; and
release a lock on the electronic device when the inclination of the electronic device is a first inclination with respect to the basic position.

2. The electronic device of claim 1, wherein
the circuitry is further configured to display a screen image prompting to incline the electronic device when the inclination of the electronic device is not the first inclination with respect to the basic position.

3. The electronic device of claim 1, wherein
the circuitry is configured to detect the basic position in which the inclination of the electronic device assumed when the user performs the first operation is substantially zero.

4. The electronic device of claim 1, wherein
the circuitry is configured to release the lock on the electronic device by inclining, with respect to the basic position, the electronic device leftward and rightward a first number of times.

5. The electronic device of claim 1, wherein
the circuitry is configured to
perform execution determination processing of determining whether release determination processing to determine whether the lock on the electronic device should be released is to be performed, when the sensor detects that the electronic device is inclined by a first angle or more with respect to the basic position;
determine that the release determination processing should be performed, and perform the release determination processing, when the sensor detects that a position in which the electronic device is inclined by the first angle is returned to the basic position, and the basic position is kept for a first period; and
release the lock on the electronic device when a result of the release determination processing is indicative of that the lock should be released.

6. A method comprising:
detecting an inclination of an electronic device;
detecting, as a basic position, a position of the electronic device assumed when a user performs a first operation; and
releasing a lock on the electronic device when the inclination of the electronic device is a first inclination with respect to the basic position.

7. The method of claim 6, further comprising displaying a screen image that encourages the user to again incline the electronic device when the inclination of the electronic device is not the first inclination with respect to the basic position.

8. The method of claim 6, wherein the detecting includes detecting the basic position in which the inclination of the electronic device assumed when the user performs the first operation is substantially zero.

9. The method of claim 6, wherein the releasing includes releasing the lock on the electronic device by inclining, with respect to the basic position, the electronic device leftward and rightward a first number of times.

10. The method of claim 6, wherein the releasing includes
performing execution determination processing of determining whether release determination processing to determine whether the lock on the electronic device should be released is to be performed, when the electronic device is detected to be inclined by a first angle or more with respect to the basic position;
determining that the release determination processing should be performed, and performing the release determination processing, when a position in which the electronic device is inclined by the first angle is returned to the basic position, and the basic position is kept for a first period; and
releasing the lock on the electronic device when a result of the release determination processing is indicative of that the lock should be released.

11. A computer-readable nonvolatile storage medium storing instructions executable by a computer, the instructions enabling the computer to perform
detecting an inclination of an electronic device;
detecting, as a basic position, a position of the electronic device assumed when a user performs a first operation; and
releasing a lock on the electronic device when the inclination of the electronic device is a first inclination with respect to the basic position.

12. The storage medium of claim 11, further storing an instruction for enabling the computer to display a screen image that encourages the user to again incline the electronic device when the inclination of the electronic device is not the first inclination with respect to the basic position.

13. The storage medium of claim 11, wherein the detecting includes detecting the basic position in which the inclination of the electronic device assumed when the user performs the first operation is substantially zero.

14. The storage medium of claim 11, wherein the releasing includes releasing the lock on the electronic device by inclining, with respect to the basic position, the electronic device leftward and rightward a first number of times.

15. The storage medium of claim 11, wherein the releasing includes
performing execution determination processing of determining whether release determination processing to determine whether the lock on the electronic device should be released is to be performed, when the electronic device is detected to be inclined by a first angle or more with respect to the basic position;
determining that the release determination processing should be performed, and performing the release determination processing, when a position in which the electronic device is inclined by the first angle is returned to the basic position, and the basic position is kept for a first period; and
releasing the lock on the electronic device when a result of the release determination processing is indicative of that the lock should be released.
